(19) United States
(12) Patent Application Publication
(10) Pub. No.: US 2019/0303990 A1
(43) Pub. Date: Oct. 3, 2019

(54) System, Method, and Apparatus for Realizing Multi-Contributor Photography

(71) Applicant: Robert Quinn, Oldsmar, FL (US)

(72) Inventor: Robert Quinn, Oldsmar, FL (US)

(21) Appl. No.: 15/943,276

(22) Filed: Apr. 2, 2018

(51) Int. Cl. G06Q 30/06; G06Q 50/00; G06T 3/40; G06K 9/00; G05D 1/10; B64C 39/02

(52) U.S. Cl. CPC G06Q 30/0621; G06Q 50/01; G06T 3/4038; B64C 2201/123; G05D 1/101; B64C 39/024; G06K 9/00624

(57) ABSTRACT

A system for generating a topographical map uses crowd sourcing to solicit drone owners to fly their drones in a predetermined pattern over one section of a desired mapping area. As drone owners perform such flights and upload the images of the predetermined pattern, those images are joined with images captured by other drone owners to produce the desired topographical map

### FIELD

This invention relates to the field of aerial photography and more particularly to a system for utilizing existing and future private drones in generating high-resolution aerial maps.

### BACKGROUND

In recent years, the entry cost for a highly-capable drone has decreased substantially. A drone is a remote-controlled flying device, typically having three or four horizontal propellers. An on-board controller receives signals from a remote device (e.g. a smartphone) and controls each of the motors, using internal gyroscopic data and positioning data (e.g. GPS). When the remote device signals the drone to move in one direction, motors interfaced to the propellers are operated at different speeds to provide a slight lift to the trailing side of the drone, thereby providing thrust in the desired direction of travel.

Recently, many reasonably priced drones include a very high-resolution camera, typically aiming in a downward direction. These drones are excellent at capturing images from above the ground. To date, there are at least 800,000 drones registered.

Unfortunately, after the purchase of an expensive drone, many hobbyists lose interest in their drone and the drone winds up in storage.

It is known that by flying a drone in a pattern and capturing images at specific intervals, it is possible to join or mosaic the captured images into a single topographical map. Such maps are very useful for many reasons including real estate, crops, surveys, land management, storm assessment, etc. In the past, such maps have been typically captured by a single drone owner.

In the past, a single drone owner (or small aircraft owner) would fly patterns over an area of interest to capture images, and then the images are mosaicked together to form a single topographical map. This is feasible for a small area, but based upon battery life and range ability of a single drone, it is almost impossible to generate a topographical map of a very large area. Although it is feasible for a small aircraft, many such companies have gone dark due to the cost of the aircraft, insurance, maintenance, fuel, storage, landing fees, etc., and such is no longer financially possible.

For example, a recent hurricane struck Puerto Rico. As much of the infrastructure was destroyed by the hurricane, there was much difficulty in assessing the severity of damage, locating those with critical needs, providing search and rescue operations, etc. As Puerto Rico is approximately 5,300 square miles, it would be almost impossible to produce a topological map of high detail without traversing the entire island. Satellite imaging does not show enough detail to fully understand the extent of this disaster. A new way to produce a topological map of such a vast area of interest is needed.

U.S. pat. application. no. 2017/025991 to Michael Winn, et al. describes a method for adaptive mission execution by an unmanned aerial vehicle (e.g. a drone).

What is needed is a system that will provide incentives for drone owners to fly their drones in specified patterns, capturing images at specified altitudes and locations for joining images from multiple drones into on topographical map.

### SUMMARY

A system uses crowd sourcing to solicit drone owners to fly their drones in a predetermined pattern over one section of a desired mapping area. As drone owners perform such flights and upload the images of the predetermined pattern, those images are joined with images captured by other drone owners to produce the desired topographical map.

In one embodiment, a system for realizing multi-contributor photography is disclosed including an area of interest that is specified by a client. The area of interest is presented (e.g. entered/uploaded) to a server computer. A fee for providing a topographic image of the area of interest is provided to the client. If the fee is approved, the area of interest is divided into a plurality of job sections and the plurality of job sections are advertised (e.g. crowdsourced on the Internet). As each job section in the plurality of job sections is requested by a user, a flight plan for a requested job section of the plurality of job sections is downloaded to a user control device associated with the user and the user then runs the flight plan, capturing multiple images of the requested job section. Upon completion of the flight plan, the multiple images are uploaded from the user control device to the server computer. Then, upon completion of the plurality of job sections the multiple images that were uploaded to the server computer for all of the plurality of job sections is mosaicked (e.g. aligned and combined) into a single orthorectified mosaic image and the single orthorectified mosaic image is provided to the client.

In another embodiment, a method for realizing multi-contributor photography is disclosed including receiving an area of interest from a client and proposing a fee for providing a topographic image of the area of interest to the client. If the fee is approved, the area of interest is divided into a plurality of job sections, which are then advertised (to users). As each job section in the plurality of job sections is requested by a user, a flight plan for a requested job section is downloaded to a user control device associated with the user. Responsive to the downloading of the flight plan, the user runs the flight plan and captures multiple images of the requested job section. Upon completion of the flight plan, the multiple images from the user control device are uploaded to a server computer. Then, upon completion of the plurality of job sections, the server computer mosaics (combines) the multiple images that were uploaded for all of the plurality of job sections into a single orthorectified mosaic image and provides the single orthorectified mosaic image to the client.

In another embodiment, program instructions tangibly embodied in a non-transitory storage medium for realizing multi-contributor photography are disclosed. The at least one instruction includes computer readable instructions running on a server computer that receives an area of interest from a client and then presents a fee for providing a topographic image of the area of interest to the client. If the fee is approved, computer readable instructions running on the server computer divide the area of interest into a plurality of job sections and then advertise the plurality of job sections (e.g. to users/pilots). As each job section in the plurality of job sections is requested by a user, computer readable instructions running on the server computer download a flight plan for a requested job section to a user control device associated with the user and computer readable instructions running on the user control device store the flight plan. Responsive to the downloading of the flight plan, computer readable instructions running on the user control device runs the flight plan and captures multiple images of the requested job section. Upon completion of the flight plan, computer readable instructions running on the user control device upload the multiple images from the user control device to the server computer, then, upon completion of the plurality of job sections, computer readable instructions running on the server computer combine the multiple images that were uploaded for all of the plurality of job sections into a single orthorectified mosaic image and provide the single orthorectified mosaic image to the client.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates an example of a drone of the prior art.

FIG. 2 illustrates a data connection diagram of the system for realizing multi-contributor photography.

FIG. 3 illustrates a typical user control device (e.g. smartphone).

FIG. 4 illustrates a schematic view of a typical computer system such as a server or personal computer.

FIG. 5 illustrates an exemplary area of interest of the system for realizing multi-contributor photography.

FIG. 6 illustrates the exemplary area of interest of the system for realizing multi-contributor photography with a requested job highlighted.

FIG. 7 illustrates the exemplary area of interest of the system for realizing multi-contributor photography with a requested job highlighted showing a flight plan.

FIGS. 8-10 illustrate an exemplary program flow of the system for realizing multi-contributor photography.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Throughout the description, the term “drone” is used to describe a flying device that typically has positioning and gyroscopic capabilities and is controlled remotely. Current day drones typically have four independently operated motors, each having a propeller that directs air downward, therefore providing lift and movement to the drone. As the technology of the drone progresses, the system described herein anticipates any and all current or future drone technology for capturing images of land areas (buildings, cars, etc.).

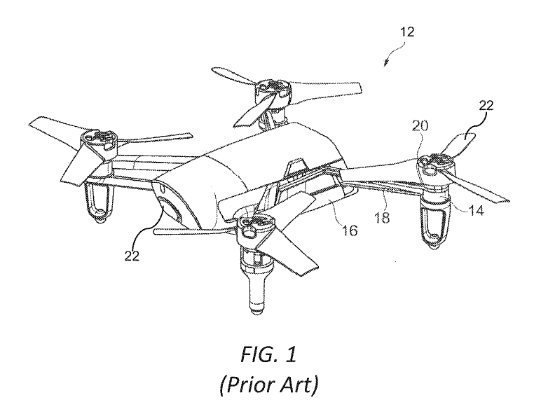

Referring to FIG. 1, a typical drone of the prior art is shown. The drone 12 has a body section 16 that houses, for example, a gyroscope, a global positioning system (GPS), a battery pack, a wireless transceiver for receiving commands from a pilot, and control circuitry. The control circuitry selectively provides power to a plurality of motors 20 that, in turn, rotate propellers 22 to fly and maneuver this drone 12. One or more cameras capture images or video when requested to do so by the control circuitry.

Note that there are many types and configurations of such drones, all of which are included in this application.

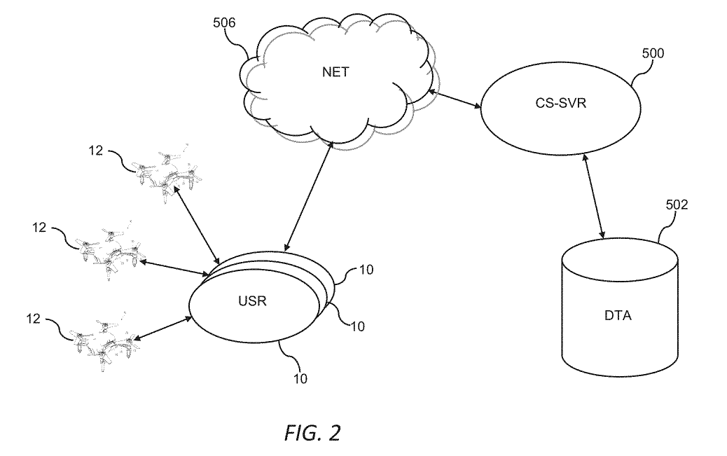

Referring to FIG. 2, a data connection diagram of the system for realizing multi-contributor photography is shown. In this example, one or more user control device 10 (e.g. smartphones) communicate through a network 506 (e.g. the cellular network and/or through a wide area network such as the Internet) to a campaign server computer 500.

The campaign server computer 500 has access to data storage 502 for storing campaigns, waypoints, captured images, billing information, payment information, etc. Although one path between the user control devices 10 and the campaign server computer 500 is through one or more networks 506 including, for example, a cellular network and/or a wide area network, any known data path is anticipated.

The campaign server computer 500 transacts with the user control devices 10 through the network(s) 506 to present offers, download lists of waypoints, upload images, etc. In some embodiments, login credentials (e.g., passwords, pins, secret codes) are stored local to the user control devices 10; while in other embodiments, login credentials are stored in a data storage 502 (preferably in a secured area) requiring a connection to the campaign server computer 500 in order to login.

The campaign server computer 500 transacts with applications running on the user control devices 10.

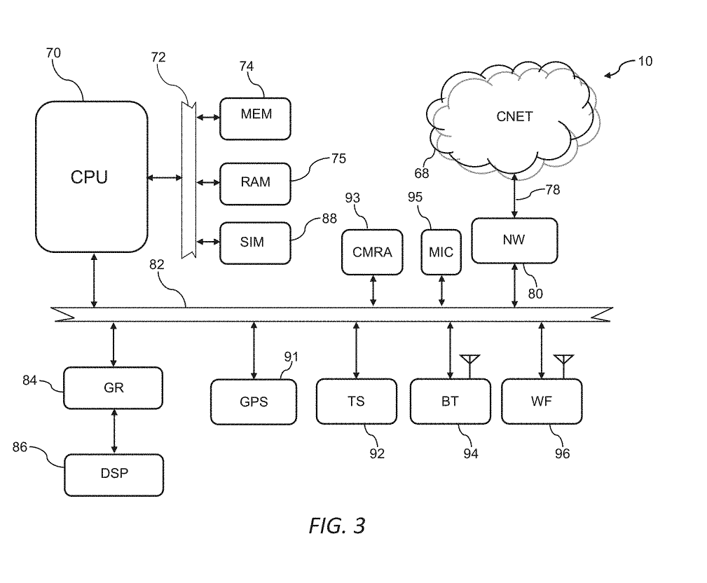

Referring to FIG. 3, a schematic view of a typical user control device 10 is shown. This exemplary user control device 10 is a smartphone typically used for controlling the drones 12. This exemplary user control device 10 is shown in its simplest form. Different architectures are known that accomplish similar results in a similar fashion and the present invention is not limited in any way to any particular user control device 10 system architecture or implementation. In this exemplary user control device 10, a processor 70 executes or runs programs in a random access memory 75. The programs are generally stored within a persistent memory 74 and loaded into the random access memory 75 when needed. Also accessible by the processor 70 is a SIM card 88 (subscriber information module) having a subscriber identification and often persistent storage. The processor 70 is any processor, typically a processor designed for phones. The persistent memory 74, random access memory 75, and SIM card are connected to the processor by, for example, a memory bus 72. The random access memory 75 is any memory suitable for connection and operation with the selected processor 70, such as SRAM, DRAM, SDRAM, RDRAM, DDR, DDR-2, etc. The persistent memory 74 is any type, configuration, capacity of memory suitable for persistently storing data, for example, flash memory, read only memory, battery-backed memory, magnetic memory, etc. In some exemplary user control devices 10, the persistent memory 74 is removable, in the form of a memory card of appropriate format such as SD (secure digital) cards, micro SD cards, compact flash, etc.

Also connected to the processor 70 is a system bus 82 for connecting to peripheral subsystems such as a cellular network interface 80, a graphics adapter 84 and a touch screen interface 92. The graphics adapter 84 receives commands from the processor 70 and controls what is depicted on a display image on the display 86. The touch screen interface 92 provides navigation and selection features.

In general, some portion of the persistent memory 74 and/or the SIM card 88 is used to store programs, executable code, phone numbers, contacts, and data, etc. In some embodiments, other data is stored in the persistent memory 74 such as audio files, video files, text messages, etc.

The peripherals are examples and other devices are known in the industry such as Global Positioning Subsystem 91, speakers, microphones, USB interfaces, Bluetooth transceiver 94, Wi-Fi transceiver 96, camera 93, microphone 95, image sensors, temperature sensors, etc., the details of which are not shown for brevity and clarity reasons.

The cellular network interface 80 connects the user control device 10 to the cellular network 68 (and eventually the network 506) through any cellular band and cellular protocol such as GSM, TDMA, LTE, etc., through a wireless medium 78. There is no limitation on the type of cellular connection used. The cellular network interface 80 provides voice call, data, and messaging services to the user control device 10 through the cellular network.

For local communications, many user control devices 10 include a Bluetooth transceiver 94, a Wi-Fi transceiver 96, or both. Such features of user control devices 10 provide data communications between the user control devices 10 and data access points and/or other computers such as a personal computer (not shown).

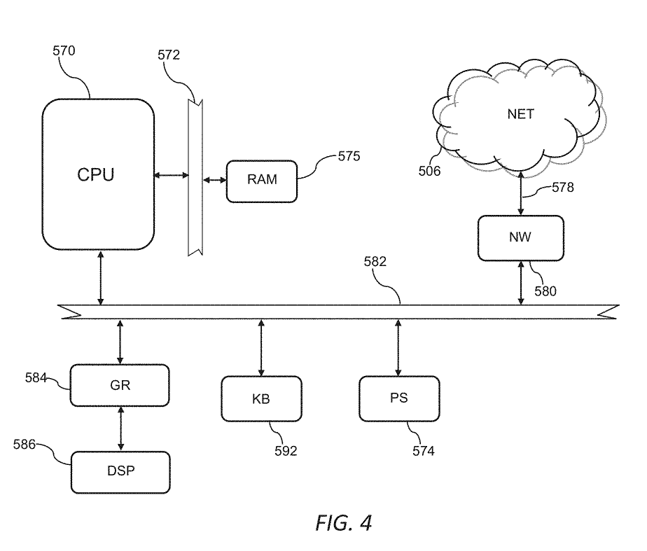

Referring to FIG. 4, a schematic view of a typical computer system (e.g., campaign server computer 500) is shown. The example computer system represents a typical computer system used for the campaign server computer 500 for back-end processing, generating reports, displaying data, etc. This exemplary computer system is shown in its simplest form. Different architectures are known that accomplish similar results in a similar fashion and the present invention is not limited in any way to any particular computer system architecture or implementation. In this exemplary computer system, a processor 570 executes or runs programs in a random access memory 575. The programs are generally stored within a persistent memory 574 and loaded into the random access memory 575 when needed. The processor 570 is any processor, typically a processor designed for computer systems with any number of core processing elements, etc. The random access memory 575 is connected to the processor by, for example, a memory bus 572. The random access memory 575 is any memory suitable for connection and operation with the selected processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, magnetic memory, etc. The persistent memory 574 is typically interfaced to the processor 570 through a system bus 582, or any other interface as known in the industry.

Also shown connected to the processor 570 through the system bus 582 is a network interface 580 (e.g., for connecting to a network 506), a graphics adapter 584 and a keyboard interface 592 (e.g., Universal Serial Bus—USB). The graphics adapter 584 receives commands from the processor 570 and controls what is depicted on a display image on the display 586. The keyboard interface 592 provides navigation, data entry, and selection features.

In general, some portion of the persistent memory 574 is used to store programs, executable code, data, waypoints, and other data, etc.

The peripherals are examples and other devices are known in the industry such as speakers, microphones, USB interfaces, Bluetooth transceivers, Wi-Fi transceivers, image sensors, temperature sensors, etc., the details of which are not shown for brevity and clarity reasons.

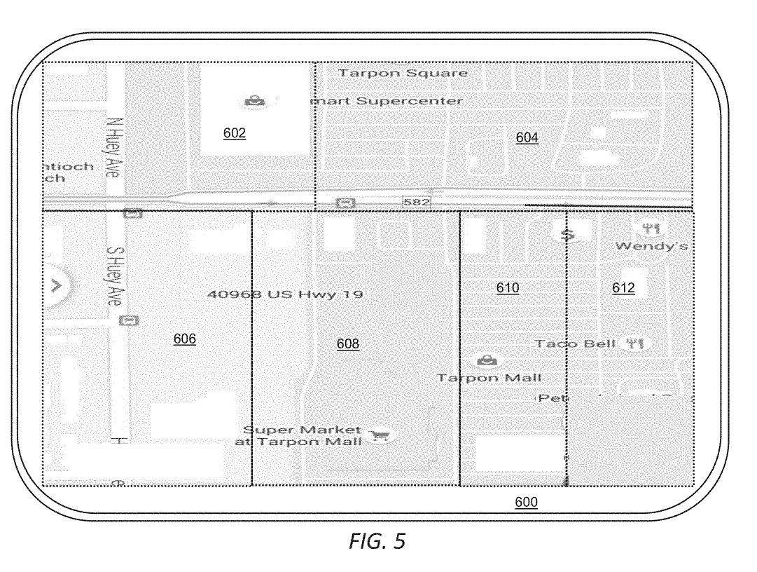

Referring to FIG. 5, an exemplary area of interest 600 of the system for realizing multi-contributor photography is shown. A client desires a orthorectified mosaic image of an area of interest 600 and agrees to pay a fee for such orthorectified mosaic image or pre-pays for such orthorectified mosaic image.

In this, an example of an area of interest 600 is shown divided into job sections 602/604/606/608/610/612. Although the area of interest 600, and for that matter, the job sections 602/604/606/608/610/612 are shown substantially rectangular, there is no restriction as to the size, shape, and topography of the area of interest 600 the job sections 602/604/606/608/610/612. For another example, an area of interest 600 is Pinellas County, Florida, which does not have straight-line borders. In such, at least some of the job sections 602/604/606/608/610/612 are irregular, hence not rectangular.

The area of interest 600 is an area of land that is of interest to a buyer who is interested in the geography of that land area, perhaps for purchase or for mapping or other geological purposes. The buyer pays to have a orthorectified mosaic image of the land area, which is typically too large of a land area for a single drone 12 to cover, and, therefore, the area of interest 600 is divided into a plurality of job sections 602/604/606/608/610/612, each sized to be coverable by a single drone 12.

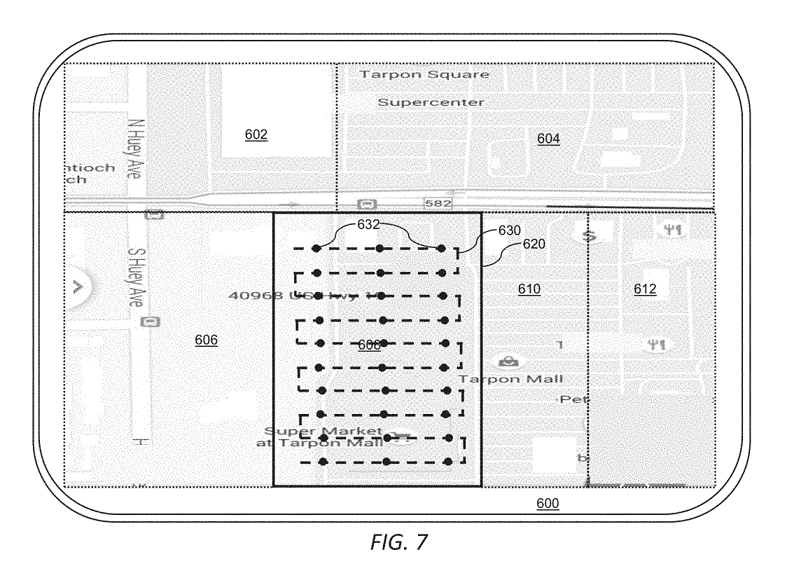

The job sections 602/604/606/608/610/612 are divisions of the area of interest 600 created either algorithmically or manually by a human operator. It is deemed that each of the job sections 602/604/606/608/610/612 are coverable by a drone 12. The job sections 602/604/606/608/610/612 are a subdivision of the overall area of interest 600 that will be partitioned out to a drone owner and, the drone owner will fly a prescribed flight plan 630 (see FIG. 7) over the agreed job section 602/604/606/608/610/612, typically in exchange for some type of enumeration (e.g. a payment or a prize).

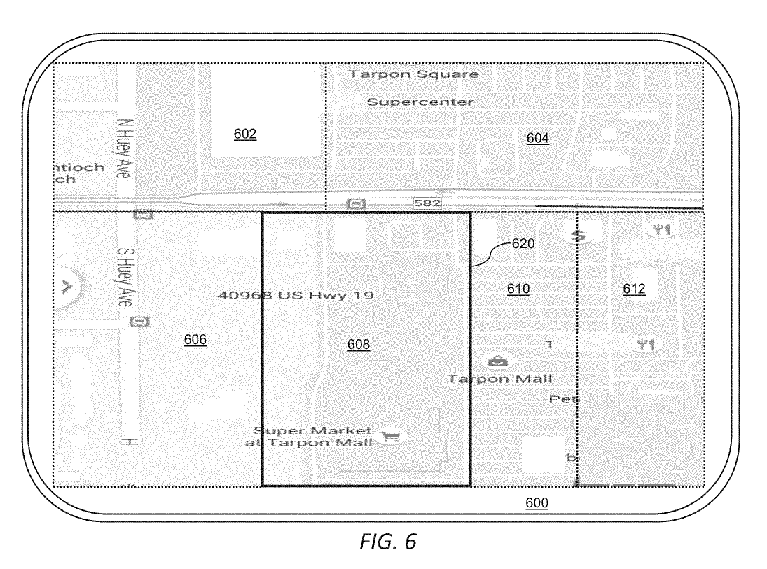

Referring to FIG. 6, the exemplary area of interest 600 of the system for realizing multi-contributor photography with a requested job section 620 highlighted is shown. Once the area of interest 600 is defined and divided into job sections 602/604/606/608/610/612, an offer is made to a plurality of drone owners (pilots) through, for example, the Internet. As a drone owner agrees to provide images for a particular job section 602/604/606/608/610/612, that job section 602/604/606/608/610/612 is allocated to that drone owner. In FIG. 6, a requested job section 620 has been selected by a drone owner who agrees to provide images of this requested job section 620, typically for a fee or other enumeration such as a gift or prize, etc.

Referring to FIG. 7, the exemplary area of interest 600 of the system for realizing multi-contributor photography is shown with a requested job section 620 highlighted and including a flight plan 630. Once the drone owner selects a requested job section 620 and agrees to provide images of this requested job section 620, the requested job section 620 is reserved for that drone owner and a flight plan 630 is downloaded to a user control device 10 associated with that drone owner. At some time after receiving the flight plan 630, the drone owner runs their mission by visiting the location of the requested job section 620, loads the flight plan 630 into their drone 12, and initiates their drone 12 to fly the flight plan 630. The flight plan 630 includes instructions for the drone 12 to capture images at specific image points 632.

Once the mission is complete, the drone owner uploads the images from the drone 12 to the user control device 10, then to the campaign server computer 500 and the images are checked for completeness and quality. Once a full set of acceptable images required by the flight plan 630 are uploaded to the campaign server computer 500, the mission is deemed complete for the requested job section 620 and any enumeration to the drone owner is initiated.

Once missions are finished for all job sections 602/604/606/608/610/612, all of the images are combined into a single orthorectified mosaic image through a process of mosaicking. The single orthorectified mosaic image is then provided to the client, in some embodiments, after the client pays a fee for the single orthorectified mosaic image.

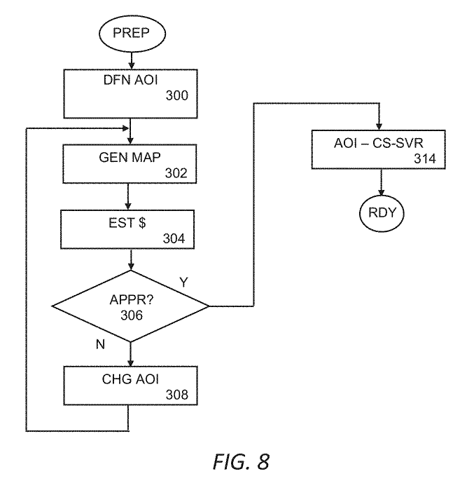

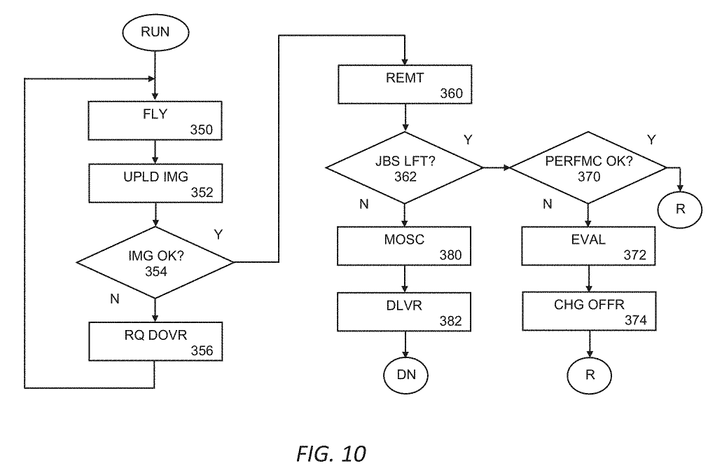

Referring to FIGS. 8-10, an exemplary program flow of the system for realizing multi-contributor photography is shown. To start, the area of interest 600 is defined 300 as requested by a client. A rough map of the area of interest 600 is created 302 and an estimate of the cost to provide a single topographical image of the area of interest 600 is made 304. If the estimated cost of the single topographical image of the area of interest 600 is not approved 306 by the client, modifications are made 308 until the estimated cost of the single topographical image of the area of interest 600 is approved 306 by the client and, upon approval, the area of interest 600 is uploaded 314 to the campaign server computer 500 for generating the campaign.

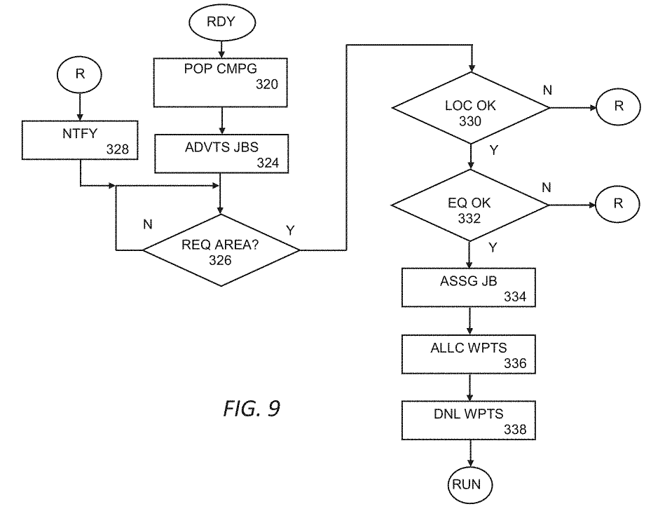

In FIG. 9, the campaign is populated 320 which includes dividing the area of interest 600 into job sections 602/604/606/608/610/612. Next, the job sections 602/604/606/608/610/612 are advertised 324 to a plurality of potential users/pilots. The process continues until a request is made 326 for one of the job sections 602/604/606/608/610/612. If the location of the user/pilot doesn't match 330 the requested job section 602/604/606/608/610/612 or the equipment of the user/pilot doesn't meet the requirements 332 for the requested job section 602/604/606/608/610/612, the user/pilot is notified of such 328 and the process continues to request potential users/pilots.

If the location of the user/pilot does match 330 the requested job section 602/604/606/608/610/612 and the equipment of the user/pilot meets the requirements 332 for the requested job section 602/604/606/608/610/612, the requested job section 620 is assigned 334 to that user/pilot and the waypoints associated with the requested job section 620 are allocated 336. The waypoints for the requested job section 620 are downloaded 338 to the user control device 10 for programming the user's/pilot's drone 12.

There are many program flows anticipated. For example, in some, all job sections 602/604/606/608/610/612 are assigned before the flight plans 630 are distributed and flight plans 630 are run. In this exemplary program flow, once the requested job section 620 is assigned 334 and the flight plan 630 is downloaded, the user/pilot runs 350 the flight plan 630. After the user/pilot runs 350 the flight plan 630, the captured images are uploaded 352 to the campaign server computer 500 and the completeness and quality 354 of the images are checked. If the completeness and quality 354 of the images are not satisfactory, the user/pilot is requested to rerun the flight plan 630 and the above steps 350-354 are repeated.

If the completeness and quality 354 of the images are satisfactory, any promised enumeration is made 360 to the user/pilot. If there still remain 362 more uncompleted job sections 602/604/606/608/610/612 then it is determined 370 if the overall performance of the campaign is as promised to the client. If it is determined 370 that the overall performance of the campaign is satisfactory, the above steps are repeated with the next user/pilot for another job section 602/604/606/608/610/612. If it is determined 370 that the overall performance of the campaign is not satisfactory, then the reasons for such performance are evaluated 372 (e.g. the incentive/enumeration is too low or a size of each job section 602/604/606/608/610/612 is too big), then the offer is changed 374 (e.g. providing additional incentive/enumeration is too low or decreasing the size of each job section 602/604/606/608/610/612) and the above steps are repeated (re-advertising) with the next user/pilot for another job section 602/604/606/608/610/612 and the improved offer.

If there are no remaining 362 uncompleted job sections 602/604/606/608/610/612 then the captured images that were uploaded to the campaign server are combined by mosaicking 380 and the single topographical image of the area of interest 600 is delivered 382 to the client.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for realizing multi-contributor photography, the system comprising:
an area of interest as specified by a client;
the area of interest is presented to a server computer;
a fee for providing a topographic image of the area of interest is provided to the client;
if the fee is approved, the area of interest is divided into a plurality of job sections and the plurality of job sections are advertised;
as each job section in the plurality of job sections is requested by a user, a flight plan for a requested job section of the plurality of job sections is downloaded to a user control device associated with the user and the user then runs the flight plan, capturing multiple images of the requested job section;
upon completion of the flight plan, the multiple images are uploaded from the user control device to the server computer;
upon completion of the plurality of job sections the multiple images that were uploaded to the server computer for all of the plurality of job sections is mosaicked into a single orthorectified mosaic image; and
the single orthorectified mosaic image is provided to the client.

2. The system of claim 1, wherein before the single orthorectified mosaic image is provided to the client, the fee is received from the client.

3. The system of claim 1, wherein after the multiple images are uploaded from the user control device to the server computer, the multiple images are checked for quality and, if the multiple images lack quality, the flight plan for the requested job section is again downloaded to the user control device associated with the user and the flight plan is rerun, recapturing the multiple images of the requested job section, and upon completion of the flight plan, the multiple images are uploaded from the user control device to the server computer.

4. The system of claim 1, wherein the plurality of job sections are advertised along with an enumeration for each job section of the plurality of job sections.

5. The system of claim 4, wherein if there is a lack of interest in any job section in the plurality of job sections, the any job sections are re-advertised along with an increased enumeration for the any job section of the plurality of job sections.

6. The system of claim 4, wherein the enumeration comprises a payment of money.

7. A method for realizing multi-contributor photography, the method comprising:
receiving an area of interest from a client;
proposing a fee for providing a topographic image of the area of interest to the client;
if the fee is approved, dividing the area of interest into a plurality of job sections;
advertising the plurality of job sections;
as each job section in the plurality of job sections is requested by a user, downloading a flight plan for a requested job section of the plurality of job sections to a user control device associated with the user;
responsive to the downloading of the flight plan, the user running the flight plan and capturing multiple images of the requested job section;
upon completion of the flight plan, uploading of the multiple images from the user control device to a server computer;
upon completion of the plurality of job sections, the server computer mosaicking the multiple images that were uploaded for all of the plurality of job sections into a single orthorectified mosaic image; and
providing the single orthorectified mosaic image to the client.

8. The method of claim 7, wherein before the single orthorectified mosaic image is provided to the client, receiving the fee from the client.

9. The method of claim 7, wherein after the step of uploading of the multiple images from the user control device to the server computer, checking of the multiple images for quality and, if the checking of the multiple images indicating a lack quality, again downloading the flight plan for the requested job section to the user control device associated with the user and the user rerunning the flight plan, recapturing the multiple images of the requested job section, and upon completion of the flight plan, uploading of the multiple images from the user control device to the server computer.

10. The method of claim 7, wherein the step of advertising the plurality of job sections includes advertising an enumeration for each job section of the plurality of job sections.

11. The method of claim 10, wherein if there is a lack of interest in any job section in the plurality of job sections, re-advertising the any job section with an increased enumeration for the any job section.

12. The method of claim 10, wherein the enumeration comprises paying an amount of money.

13. The method of claim 10, wherein the enumeration comprises providing a gift.

14. Program instructions tangibly embodied in a non-transitory storage medium for realizing multi-contributor photography, wherein the at least one instruction comprises:
computer readable instructions running on a server computer receive an area of interest from a client;
computer readable instructions running on the server computer present a fee for providing a topographic image of the area of interest to the client;
if the fee is approved, computer readable instructions running on the server computer divide the area of interest into a plurality of job sections;
computer readable instructions running on the server computer advertise the plurality of job sections;
as each job section in the plurality of job sections is requested by a user, computer readable instructions running on the server computer download a flight plan for a requested job section of the plurality of job sections to a user control device associated with the user and computer readable instructions running on the user control device store the flight plan;
responsive to the downloading of the flight plan, computer readable instructions running on the user control device run the flight plan and capture multiple images of the requested job section;
upon completion of the flight plan, computer readable instructions running on the user control device upload the multiple images from the user control device to the server computer;
upon completion of the plurality of job sections, computer readable instructions running on the server computer combine the multiple images that were uploaded for all of the plurality of job sections into a single orthorectified mosaic image; and
computer readable instructions running on the server computer provide the single orthorectified mosaic image to the client.

15. The Program instructions tangibly embodied in the non-transitory storage medium for realizing multi-contributor photography of claim 14, wherein before the single orthorectified mosaic image is provided to the client, computer readable instructions running on the server computer receives the fee from the client.

16. The Program instructions tangibly embodied in the non-transitory storage medium for realizing multi-contributor photography of claim 14, wherein after the step of the computer readable instructions running on the server computer uploads of the multiple images from the user control device to the server computer, computer readable instructions running on the server computer check the multiple images for quality and, if the multiple images lack quality, computer readable instructions running on the server computer download the flight plan for the requested job section to the user control device associated with the user and computer readable instructions running on the user control device rerun the flight plan, recapture the multiple images of the requested job section, and upon completion of the flight plan, computer readable instructions running on the user control device upload the multiple images from the user control device to the server computer.

17. The Program instructions tangibly embodied in the non-transitory storage medium for realizing multi-contributor photography of claim 14, wherein the computer readable instructions running on the server computer advertise the plurality of job sections includes computer readable instructions running on the server computer that advertise an enumeration for each job section of the plurality of job sections.

18. The Program instructions tangibly embodied in the non-transitory storage medium for realizing multi-contributor photography of claim 17, wherein if there is a lack of interest in any job section in the plurality of job sections, computer readable instructions running on the server computer re-advertise the any job section with an increased enumeration for the any job section.

19. The Program instructions tangibly embodied in the non-transitory storage medium for realizing multi-contributor photography of claim 17, wherein the enumeration comprises an amount of money.

20. The Program instructions tangibly embodied in the non-transitory storage medium for realizing multi-contributor photography of claim 17, wherein the enumeration comprises a gift.
